(19) United States
(12) Patent Application Publication
(10) Pub. No.: US 2009/0224439 A1
(43) Pub. Date: Sep. 10, 2009

(54) INJECTION MOLDING APPARATUS AND METHODS FOR MAKING PLASTIC PREFORMS

(75) Inventors: Keith Barker, Bedford, NH (US); Brian Lynch, Merrimack, NH (US); Thomas Nahill, Amherst, NH (US)

Correspondence Address: RISSMAN HENDRICKS & OLIVERIO, LLP, 100 Cambridge Street, Suite 2101, BOSTON, MA, 02114, US

(73) Assignee: Graham Packaging Company, LP, York, PA (US)

(21) Appl. No.: 12/044,082

(22) Filed: Mar. 7, 2008

(51) Int. Cl. B29C 45/72

(52) U.S. Cl. 264/537; 425/547

(57) ABSTRACT

A method of making plastic preforms may include molding one or more preforms in an injection molding apparatus, moving the preforms into cooling tubes while the preforms are in a deformable state, and while the preforms are being cooled in the cooling tubes to a temperature at which deformation of the preforms is resisted, crystallizing a portion of the preforms.

### TECHNICAL FIELD

The present invention is directed generally to injection molding apparatus and methods of making plastic preforms. More particularly, the present invention is directed to crystallizing a portion of a preform while cooling the preform.

### BACKGROUND

Conventional manufacture of plastic (e.g. polyethylene terephthalate (PET)) containers employs an initial step of forming a substantially amorphous and unoriented parison or preform by an injection molding process. A process of crystallizing the finish of the preform is sometimes used to thermally stabilize the dimensions of the finish. This crystallization process is generally a separate operation performed between the injection molding process and a later blow molding process.

When performed as a separate operation, the crystallization process significantly increases the cost of production by way of increased equipment costs and operational expenses for each additional piece of equipment required (i.e., perform handling and transfer apparatus and crystallizer), increased further by the cost of custom tooling for each specific product undergoing this additional operation. As a further detriment, the additional handling increases the opportunities for damaging the preforms.

### SUMMARY OF THE INVENTION

In accordance with various embodiments of the present invention, it is desirable to provide a process and apparatus for crystallizing a portion of a preform during cooling of the injection molded preform. Preferably, the crystallization can be accomplished without significantly increasing the cost of the container product and/or the operation (cycle) time for producing the preforms. This may be accomplished by crystallizing a portion of the preform while the preform is being cooled in a cooling, or take-off, tube. Preferably, the preform molding, cooling and crystallization is performed as a batch process on a plurality of preforms.

In accordance with one embodiment of the invention, a method of making a plastic preform comprises molding at least one preform in an injection molding apparatus, moving the at least one preform to a cooling tube while the at least one preform is in a deformable state, cooling the at least one preform from the deformable state to a temperature at which deformation of the at least one preform is resisted, and crystallizing a portion of the at least one preform during the cooling step.

According to another embodiment of the invention, a method of making a plastic preform comprises molding at least one preform in an injection molding apparatus, moving the at least one preform to a cooling tube while the at least one preform is in a deformable state, cooling the at least one preform from a deformable state to a temperature at which deformation of the at least one preform is resisted, heating at least a portion of a finish of the at least one preform to crystallize the finish portion during the cooling step, and inserting a sizing plug in the finish to reduce or eliminate shape deformation due to the crystallizing. The sizing plug may be inserted prior to, during, or after the heating (crystallizing) step.

In one embodiment, the sizing plug is cooled prior to and/or after insertion into the (amorphous or crystallized) neck finish. Crystallizing will generally stop when a cool plug is inserted. A hot finish will continue to crystallize, with or without the heater present, until cooled by air or the plug.

In accordance with other aspects of the invention, an apparatus for making performs comprises an injection molding apparatus configured to mold at least one preform, a cooling tube configured to receive the at least one preform in a deformable state and to cool the preform to a temperature at which deformation of the at least one preform is resisted, and a crystallizing member configured to crystallize a portion of the at least one preform while the at least one preform is in the cooling tube.

In various embodiments, at least a portion of the finish and more particularly the top sealing surface (TSS) of the preform is crystallized. The crystallizing may be accomplished by radiant heating or by directing heated air at the preform. The heating step may be followed by a sizing step in which a plug, preferably a cooling plug, is inserted into the warm neck finish to eliminate or reduce any shape deformation that may occur due to crystallizing.

These and other embodiments will be described in the following detailed description.

### BRIEF DESCRIPTION OF THE DRAWINGS

FIGS. 1A-1D are side schematic views of an injection molding apparatus and a series of steps for crystallizing and cooling a group of preforms in accordance with one embodiment of the invention.

FIG. 2A is a side schematic view of a portion of an alternative injection molding apparatus utilizing a series of heater nozzles for crystallizing a finish portion of each of the performs in a batch, and FIG. 2B is a perspective view of one such heater nozzle.

FIG. 3 is a perspective view of one embodiment of a preform finish having a crystallized top sealing surface.

FIG. 4A is a top schematic view of a crystallizer plate in accordance with another embodiment of the invention, including alternating rows of heating elements and cooling plugs, and FIG. 4B is a side view of the crystallizer plate of FIG. 4A positioned for treating the TSS of preforms positioned in an array of cooling tubes, wherein the alternating rows of preforms are being: (a) crystallized, or (b) reshaped with a cooling plug (following crystallization).

### DETAILED DESCRIPTION

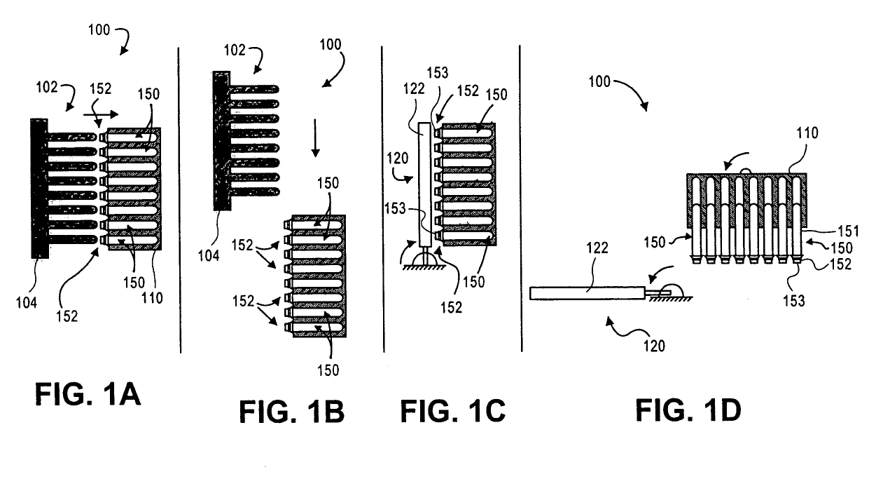

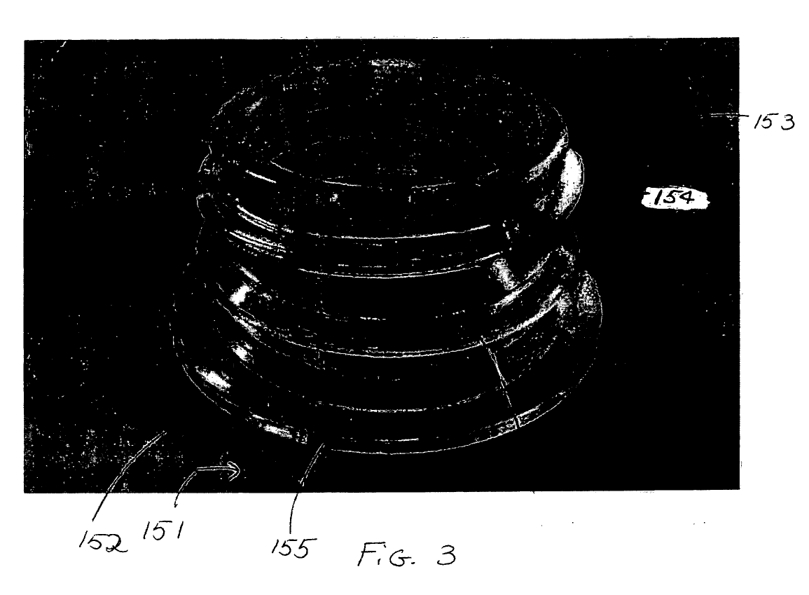

One exemplary embodiment of an injection molding apparatus and method according to the present invention is illustrated in FIGS. 1A-1D. The apparatus and method operate on an exemplary preform 150 as shown in FIGS. 1-3, the preform having a lower container body forming portion 151 (to be expanded during a subsequent blow molding process) and an upper neck finish portion 152 (for receiving a closure). The finish includes a lower capping flange 155, outer threads 154, and an uppermost top sealing surface (TSS) 153 above the threads. As shown in FIG. 3, at least the TSS (and an area immediately below the TSS and above the threads) has been thermally crystallized (now milky white as opposed to the otherwise transparent uncrystallized and amorphous neck finish and body) according to one embodiment of the present invention.

An injection molding and cooling apparatus 100 includes an array of injection mold cavities (not shown) and cores 104 configured to receive molten plastic from a source of molten plastic (not shown), as is well known in the art. Molten plastic is injected into each of the molds to form a plurality (batch) of injection molded preforms.

The injection molding and cooling apparatus 100 further includes an array of cooling tubes 110, also known as take-off tubes, configured to hold and cool the one or more preforms 150 formed by the injection molding apparatus 102. The cooling tubes 110 may comprise any known cooling tubes, as would be understood by persons skilled in the art. The cooling tubes receive the preforms 150 from the molds in a deformable state and cool the preforms down to a temperature at which deformation of the preforms is resisted. A robot (not shown) may be configured to move the cooling tubes 110 relative to the mold cores 104 (i.e., from a first position for receiving the hot performs from the cores, to a second position for cooling and/or transfer of the cooled performs to a conveyor or gaylord for collection of the cooled preforms.

As is well known in the art, the preforms 150 may be partially cooled in the molds before being ejected from the injection molds. According to various aspects, the preforms 150 may be in the mold cavities only long enough to form an exterior skin which enables their safe (relatively deformation free) transfer to the cooling tubes.

The injection and cooling apparatus 100 according to the disclosed embodiment of the invention includes a crystallizing member 120 configured to crystallize a portion of the preforms 150 while the preforms 150 are being cooled in the cooling tubes. In this embodiment, the portion of the preforms 150 to be crystallized is a portion of the finish 152 including the top sealing surface (TSS) 153. Thermal crystallization of the TSS (and optionally other portions of the finish) may be useful in later processing steps and/or during use, storage or handling of the container (e.g., blow molding of the container, hot filling, pasteurization, and/or hot caustic wash cleaning of refillable containers). A crystallized finish, which is more resistant to deformation, can improve the sealing engagement between the finish and closure (e.g., screw-on cap). In this embodiment, the crystallizing member 120 is configured to substantially complete the crystallization process (of the TSS) while the preforms are being cooled to a temperature at which deformation of the preforms is resisted (e.g., below the glass transition T_{g} temperature range of the polymer).

The crystallizing member 120 may comprise one or a series of heating elements movable relative to the cooling tubes 110 via, for example, a robot (not shown). FIG. 1C shows a heating element 122 (here a radiant infrared panel heater) positioned proximate (adjacent but spaced apart from) the TSS of the preforms 150 held in the cooling tubes 110 for crystallizing at least the TSS of the preform finish.

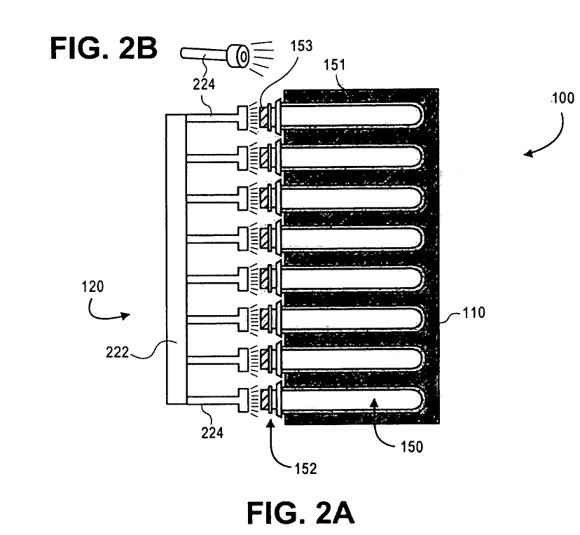

Alternatively, the crystallizing member 120 may comprise a hot air blower device 222, as illustrated in FIGS. 2A-2B, comprising a plurality of nozzles 224 each configured to direct an annular ring of heated air from a source of heated air (not shown) toward a portion, for example, the top sealing surface 153, of one of a plurality of preforms 150.

As shown in FIG. 1A, once the preforms 150 have been solidified sufficiently to be ejected from the molds, the preforms 150 may be taken off of the mold cores 104 and transferred into the cooling tubes 110 for additional cooling. Thus, the preforms 150 may be moved to the cooling tubes 110 while the preforms 150 are still in a deformable state. The use of cooling tubes 110 generally reduces the injection time (molding cycle) because the preforms can be removed earlier from the molds, allowing the cooling process to be completed in the cooling tubes (versus the molds). This frees up the molds for the next injection cycle. The cooling tubes typically include channels for circulating cold water and/or sources for directing cooled air toward the preforms. The preforms are eventually cooled to a temperature at which deformation of the preforms is resisted, e.g., the preforms can be deposited onto a conveyor or into a gaylord without substantial deformation caused by the conveying apparatus, adjacent preforms, or the transfer process. The body portion is typically the thickest portion of a preform, and generally requires more time to cool. The finish typically has more exact tolerances (than the body), e.g., of the TSS and/or the threads, to enable secure engagement with the closure. Thus, crystallizing one or more portions of the finish, at the same time the body of the preforms are being cooled in the cooling tubes, is a very efficient use of existing apparatus and a favorable cycle time can be maintained.

As shown in FIG. 1B, once the performs are transferred from the molds to the cooling tubes, the cooling tubes 110 may be moved so they are no longer proximate the cores 104. While the preforms 150 are being cooled in the cooling tubes 110, a portion of the preforms 150 may then be crystallized by moving heater element 122 proximate the finish portion of the preform. In this embodiment, the entire finish portion is positioned outside of the cooling tube and the portion of the preform to be crystallized is the top sealing surface 153. Additional portions of the finish and/or preform body may be crystallized depending upon the time, temperature, and proximity of heater 122, the preform dimensions and material, and the desired amount of crystallizing.

In one embodiment, polyester beverage bottle preforms were made from Eastman 9921PET (available from Eastman Chemical Company, Kingsport, Tenn., USA). It was found sufficient to crystallize the TSS by positioning a flat panel radiant heater at a temperature of 1000° F. about ⅜ inches from the TSS for a time between 45 and 65 seconds. Different materials will require different times/temperatures/placement (distance from) the heater. Typical crystallizable polymer materials include polyesters (e.g., polyethylene terephthalate (PET) and polyethylene naphthalate (PEN)), polyolefins (e.g. polyethylenes and polypropylenes), and polyamides. Various preform materials, blends, layer structures, etc., may be used including one or more thermocrystallizable polymers. In various embodiments, particularly for treating polyester preforms, the heater may be positioned from about ⅜ to ½ inches from the preform portion to be crystallized, the heater may be in a temperature range of about 500° F. to 1250° F., and the crystallizing may take about 30 to 75 seconds. As used herein, PET includes PET homopolymers and copolymers as is well known in the art (i.e. generally including up to 10% of other monomers). Fillers, additives, colorants, etc., may also be present in the polymer material.

FIG. 1C shows a crystallizer 120 that can be pivoted to a position proximate the cooling tubes 110. Alternatively, the crystallizer may be moved translationally to a position proximate the open ends of the cooling tubes. It should be appreciated that the crystallizer may be stationary and the cooling tubes may be translated or pivoted to a position proximate the crystallizer. The crystallizer and the cooling tubes may both be movable in any combination of the aforementioned ways to a position such that the crystallizer is proximate the relevant portion of the preforms to be crystallized, while the preforms reside in the cooling tubes.

Referring to FIG. 1D, after the top sealing surfaces 153 are crystallized and the preforms 150 are cooled, the crystallizer 120 and cooling tubes 110 may be moved relative to one another, for example, in a manner opposite to the way in which they were relatively moved proximate to one another, as discussed above. The preforms 150 may then be ejected from the cooling tubes onto a take-off belt (not shown).

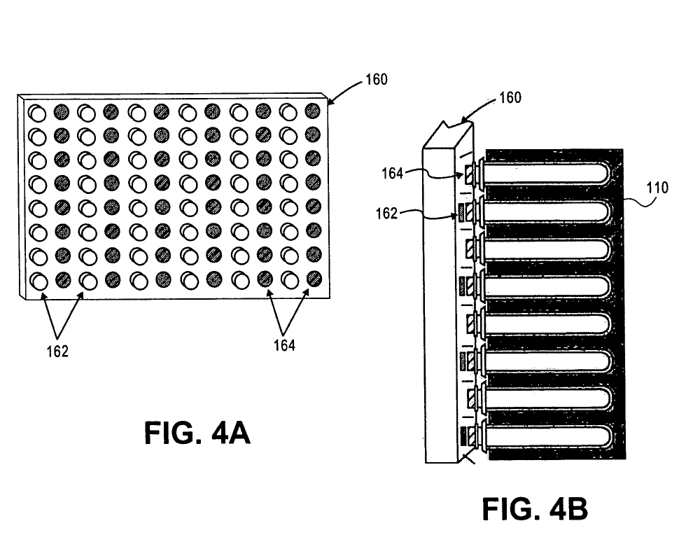

In a further embodiment, after crystallizing a finish portion of the preforms, a plug may be inserted into the crystallized finish portion while still warm (deformable) to reshape the finish in order to reduce or eliminate any shape deformation which occurred during heating and crystallizing. For example, FIGS. 4A-4B show a crystallizer plate including a plurality of heating elements and a plurality of cooling plugs arranged in alternating rows, for treating a plurality of preforms in a batch process. FIG. 4D shows schematically a portion of such a crystallizing plate positioned adjacent to a plurality of preform finishes in cooling tubes 110, wherein the cooling plugs 162 are positioned in already crystallized preform finishes in alternating rows, and heating elements 164 are positioned proximate the top sealing surfaces of the preforms to be crystallized in the other alternating rows. In various embodiments, the crystallizing plate is movable across the rows to enable first heating (crystallizing) and then resizing and further cooling of the preforms in a particular row. This type of embodiment is particularly useful insofar as the known robot cooling tubes fill alternating rows when removing the preforms from the mold cores. In one embodiment, the crystallizing plate can remain stationary while the robot (carrying the performs) moves from side to side with respect to the crystallizing plate. The cooling plugs enter the upper end of the preform finish and may be cooled with chilled water circulating through channels in the cooling plugs (e.g., cooled water at 40-50° F.).

The aforementioned apparatus and methods may increase the efficiency of producing a preform, and subsequently a container, with a crystallized portion. For example, performing the crystallization while the preforms are in the cooling tubes will reduce the handling of the preforms that would otherwise be necessitated by a separate operation and reduce the production time (compared to a separate crystallizing operation). The cost of crystallization may be kept to a minimum by using the already existing cooling tubes. Performing crystallization during the injection molding and cooling process may prevent damage to an otherwise uncrystallized portion of the preform that may occur between the injection molding and blow molding processes.

Various known preforms, injection molding apparatus and methods of making preforms may be used in the present invention, including single layer and multilayer, single material and multi-material, standard flat face multi-cavity injections molds, rotating turret molds, reciprocal shuttle molds, etc. The preform finishes may be of various types, with or without threads, optionally including a capping flange, and with or without a bead or snap-on mechanism for attaching a closure, dispensing spout, or the like.

It will be apparent to those skilled in the art that various modifications and variations can be made in the apparatus and methods of the present disclosure without departing from the scope of the invention. Other embodiments of the invention will be apparent to those skilled in the art from consideration of the specification and practice of the invention disclosed herein. It is intended that the specification and examples be considered as exemplary only.

1. A method of making a plastic preform, comprising:
molding at least one preform in an injection molding apparatus;
moving the at least one preform to a cooling tube while the at least one preform is in a deformable state;
cooling the at least one preform from the deformable state to a temperature at which deformation of the at least one preform is resisted; and
crystallizing a portion of the at least one preform during said cooling step.

2. The method of claim 1, wherein the preform includes a finish extending outside the cooling tube and at least a portion of the finish is crystallized.

3. The method of claim 2, wherein said finish portion is the top sealing surface (TSS).

4. The method of claim 2, wherein a plug is inserted in the neck finish after crystallizing to eliminate or reduce shape deformation of the finish.

5. The method of claim 4, wherein the plug cools the crystallized finish portion.

6. The method of claim 1, wherein the crystallizing comprises directing at least one of radiant heat and heated air toward the portion of the at least one preform to be crystallized.

7. The method of claim 1, further comprising moving a heater relative to the cooling tubes so that that the heater is positioned proximate the portion of the at least one preform to be crystallized.

8. The method of claim 1, wherein the moving comprises ejecting the at least one preform from an injection molding core into the cooling tube.

9. The method of claim 1, wherein the portion to be crystallized comprises a top sealing surface (TSS) of the at least one preform.

10. The method of claim 9, wherein the finish portion is crystallized in a range of about 45 seconds to 65 seconds.

11. The method of claim 9, wherein the plastic preform is made of polyester, the heater is positioned in a range of about ⅜ to ½ inches from the TSS, the heater is at a temperature in a range of about 500 to 1250° F., and the crystallizing takes about 30 to 75 seconds.

12. The method of claim 1, wherein the preform molding, cooling and crystallizing is performed as a batch process on a plurality of preforms.

13. A method of making a plastic preform, comprising:
molding at least one preform in an injection molding apparatus;
moving the at least one preform to a cooling tube while the at least one preform is in a deformable state;
cooling the at least one preform in the cooling tube from the deformable state to a temperature at which deformation of the at least one preform is resisted;
heating a finish portion of the at least one preform to crystallize the finish portion during the cooling step; and
inserting a sizing plug in the finish to reduce or eliminate shape deformation due to the crystallizing.

14. The method of claim 13, wherein the preform includes a finish extending outside the cooling tube and at least a portion of the finish is crystallized.

15. The method of claim 13, wherein the crystallized finish portion comprises a top sealing surface (TSS) of the finish.

16. The method of claim 13, wherein the sizing plug is cooled.

17. The method of claim 13, wherein the finish is cooled on the plug.

18. The method of claim 13, wherein the preform molding, cooling, crystallizing and sizing is performed as a batch process on a plurality of preforms.

19. An injection molding apparatus, comprising:
an injection molding device configured to mold at least one preform;
a cooling tube configured to receive the at least one preform in a deformable state and to cool the preform to a temperature at which deformation of the at least one preform is resisted; and
a crystallizing member configured to crystallize a portion of the at least one preform while the at least one preform is in the cooling tube.

20. The apparatus of claim 19, wherein the crystallizing member comprises a heater.

21. The apparatus of claim 20, wherein the heater is positionable proximate a finish portion of the preform to be crystallized.

22. The apparatus of claim 21, wherein the heater is positionable proximate a top sealing surface (TSS) of the finish portion.

23. The apparatus of claim 20, wherein the heater comprises a radiant or hot air heater.

24. The apparatus of claim 19, including a sizing plug positionable in a finish portion of the preform.

25. The apparatus of claim 20, wherein each of the molding device, cooling tubes, and crystallizing member are configured to handle a plurality of preforms in a batch process.
